(19) United States
(12) Patent Application Publication
(10) Pub. No.: US 2007/0171281 A1
(43) Pub. Date: Jul. 26, 2007

(54) Object initialization in video tracking

(75) Inventors: Michal Juza, Kavanova (CZ); Karel Marik, Revnice (CZ)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/337,771

(22) Filed: Jan. 23, 2006

(51) Int. Cl. H04N 7/18

(52) U.S. Cl. 348/143

(57) ABSTRACT

A system and method initializes objects in video data. In an embodiment, the video data is an output of a video tracker, and in a particular embodiment, the video tracker is a particle filter. A histogram is calculated that indicates a number of particles that do not cover an object in an input image from the particle filter at a position in the input image. The system and method then initializes an object to be tracked in the input image as a function of the histogram.

### TECHNICAL FIELD

Various embodiments relate to video surveillance and analysis, and in an embodiment, but not by way of limitation, to object initialization in video tracking.

### BACKGROUND

Video surveillance is used extensively nowadays for commercial, industrial, military, police, and government purposes. Years ago, video surveillance first started out with simple closed circuit television in combination with human monitoring thereof. It has since progressed to the capture of images, digitization of those images, the analysis of those images, and predictions and responses based on that analysis.

Object tracking is typically a large part of video surveillance systems. One method of tracking objects in video data uses a particle filter. In a typical particle filter, a finite set of particles is used to explain a scene in a video frame. The particles may be thought of as model instances that attempt to explain the video scene. For example, a particular particle may describe a scene with parameters and other information that indicate that the scene contains a person at a certain three-dimensional (3D) position x₁, y₁, z₁ moving in a direction dx₁, dy₁, dz₁, and another person at a position x₂, y₂, z₂ who is moving in a different direction dx₂, dy₂, dz₂.

A typical particle filter includes three main steps that are executed for each input frame of video data. First, in an observation step, each particle in a set of particles is compared to the current input video frame and a weight is assigned to each particle. The weight that is assigned to a particle is proportional to the ability of the particle to explain the scene in the current frame.

Second, in a re-sampling step, particles in the set of particles are replicated in proportion to each particle's weight. That is, particles with low weights are rejected and particles with high weights are replicated. Therefore, only particles that accurately explain a video scene are saved and used in the subsequent step. Depending on the particular particle filtering algorithm, one or more particles may be replicated more than once, and other particles may be discarded. The particles that are replicated more than once do not result in identical particles since particle drift and noise cause these particles to differ to some degree. In any iteration, the total number of new particles that are created through this replication and discarding process remains the same throughout the process.

In a final step of most particle filtering algorithms, sometimes referred to as the dynamic or prediction step, all the particles in the set are stochastically updated. That is, the properties of each object, such as the object's position, speed, and dimensions, in each particle are updated stochastically. This results in new set of particles that are used to process the next video frame.

The accuracy of any video tracking algorithm, and that of a particle filter algorithm in particular, is affected by the algorithm's ability to recognize and initialize new objects in a video scene. Several techniques for object initialization are known, including object initialization using unmatched motion cues, appearance probability as a function of image coordinates, random position based on uniform distribution, and initialization based on color segmentation. However, each of these techniques has its shortcomings.

The art is therefore in need of a different approach for video surveillance and monitoring, and in particular, object initialization in video tracking.

### SUMMARY

A system and method initializes objects in video data. In an embodiment, the video data is an output of a video tracker, and in a particular embodiment, the video tracker is a particle filter. A histogram is calculated that indicates a number of particles that do not cover an object in an input image from a particle filter at a position in the input image. The system and method then initializes an object to be tracked in the input image as a function of the histogram.

### BRIEF DESCRIPTION OF THE DRAWINGS

FIG. 1 illustrates an example embodiment of a process to initialize an object in a video tracker.

FIG. 2 illustrates an example embodiment of a human template.

FIG. 3 illustrates an example embodiment of a vehicle template.

FIG. 4A illustrates a binary image.

FIG. 4B illustrates an example of an Uncovered Object Histogram.

FIG. 5A illustrates an input binary image.

FIG. 5B illustrates several possible templates covering a portion of an object in the input image of FIG. 5A.

FIG. 5C illustrates a result of a template optimization procedure applied to FIG. 5B.

FIG. 6 illustrates an example embodiment of a computer architecture upon which one or more embodiments of an object initialization process may operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

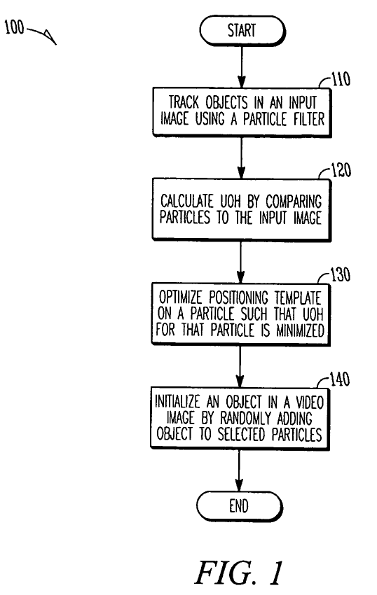

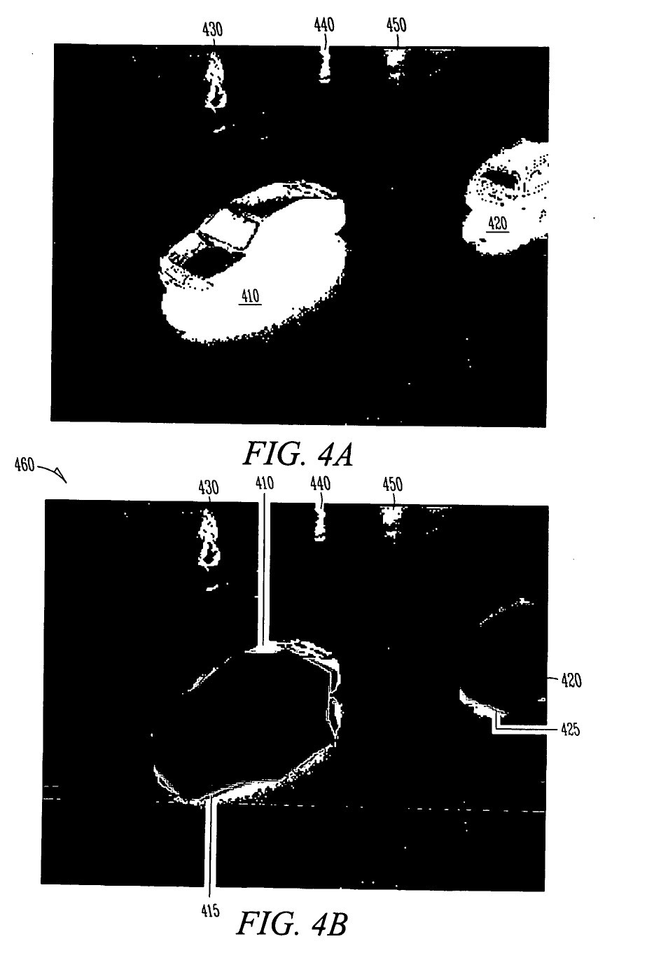

FIG. 1 illustrates an example embodiment of a process 100 to initialize objects in a video tracking system. The process 100 of FIG. 1 involves the use of a particle filter, however, those of skill in the art will realize that various other embodiments may be used in conjunction with other video tracking techniques. As illustrated in FIG. 1, at operation 110, objects are tracked in a video system using a particle filter. As explained supra, a typical particle filter tracks objects with a fixed set of particles, determines which particles in that set best describe the current video frame, replicates those particles that best describe the scene, and discards those particles that do not describe the current scene so well. In an embodiment, this comparison involves taking the current frame or output of a motion tracking algorithm, such as the frame illustrated in FIG. 4A, and comparing it to each particle in the particle set. Referring to FIG. 4A, FIG. 4A includes a binary image of a car 410 traveling in one direction, a binary image of a car 420 traveling in another direction, and binary images of persons 430, 440 and 450.

In operation 120 of FIG. 1, the process 100 calculates an Uncovered Object Histogram (UOH). An UOH allows the identification and initialization of new objects in a sequence of video data by indicating a number of particles that do not cover an input image at a position in the input image. In an embodiment, the initialization process involves an optimization algorithm using criteria based on the UOH. Those of skill in the art are familiar with several such optimization algorithms that could be used for such purposes. Thereafter, an object may be initialized in order to be tracked based on the UOH. In an embodiment, at the highest level, a UOH is calculated by comparing a projection of the particles in a particle set to the input image, and noting on the histogram those objects that appear as new objects.

FIG. 4B illustrates a grayscale image of an UOH 460 created by comparing each particle in a set to the current binary input image. As illustrated in FIG. 4B, the two vehicles 410 and 420 appear as predominantly darkened images, with a small amount of gray areas 415 and 425 around the perimeter of the darkened area. The persons 430, 440, and 450 by comparison are still completely white binary images. The darkened cars images in FIG. 4B indicate that the cars are currently being tracked in the video sequence in general, and in the current frame in particular, and that the persons are not being tracked. Since the persons are not being tracked, they are candidates for initialization as new objects.

In a particular embodiment, the comparison involves a summation of a number of particles in the particle set that do not cover the binary input image (from the motion detection algorithm) at a given position in the frame. In an embodiment, this summation is not executed over the entire frame, but only over the areas of the frame in which the motion detector has detected motion in the input frame. A particle is determined not to cover the binary input image (that is, the object in the binary input image is not recognized by a particle) if that area of the particle does not have the same value as the corresponding area on the input image. In particular, the binary value of the current image is a binary ‘1’, and the binary value of the corresponding area in the particle is a binary ‘0’. In an embodiment, this summation may be represented as follows:

$$UOH ( w , h ) = \{ \begin{matrix}{\sum }_{i = 1}^{N} ( {v}_{i} ( w , h ) ) , & if q ( w , h ) = 1 , \\ 0 & otherwise .\end{matrix}$$

wherein q(w,h) comprises a binary value of an input image at a position w,h;

wherein vᵢ(w,h) comprises a binary value of a particle i at the position w,h; and

wherein N comprises the number of particles in the particle set.

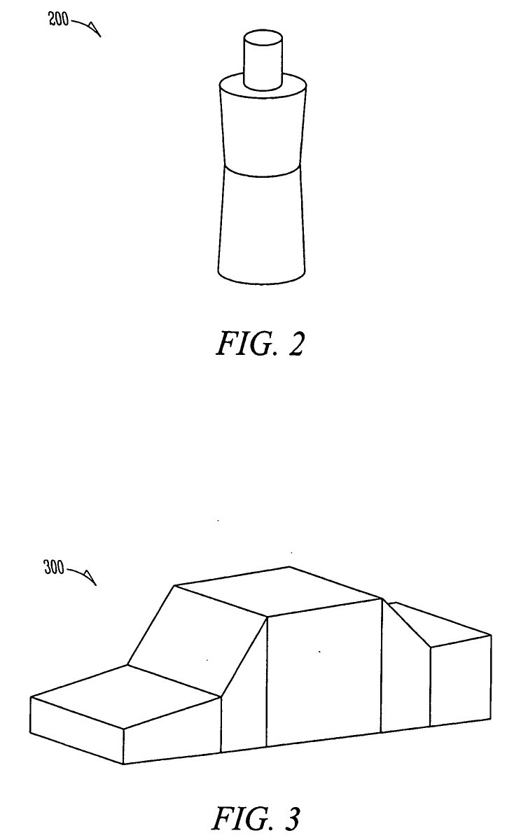

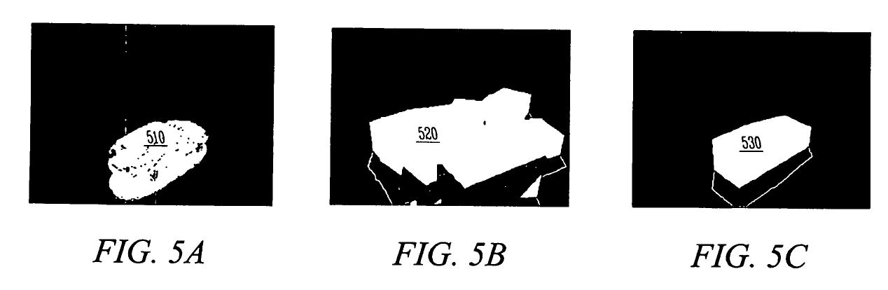

After the calculation of the UOH, an optimization is performed at operation 130 so as to most accurately position the new object in its initialization position. In an embodiment, this optimization process includes creating another UOH, which may be referred to as a virtual UOH, by placing a template in a three dimensional space and virtually adding this new object to all particles in the particle set. The virtual UOH is then created by calculating the UOH using the above-disclosed equation for this new virtual set of particles. FIG. 5A illustrates an example binary input image of a vehicle 510, and FIG. 5B illustrates the position of several vehicle templates 520 in an optimization process. The virtual UOH is computed over all particles in the particle set with the template placed therein. In an embodiment, if the motion tracker includes an object classifier, the object classifier determines what type of object is to be initialized (e.g., a person or a vehicle). With that information, a template of a given object is used in the virtual UOH. An example of a human template 200 is illustrated in FIG. 2, and an example of a vehicular template 300 is illustrated in FIG. 3.

Then, in an embodiment, the templates minimize the calculated UOH when the templates are added to all the particles in the particle set. In an embodiment, the minimization may be expressed as follows:

$$arg min {\sum }_{w = 1}^{W} {\sum }_{h = 1}^{H} {UOH}_{o} ( w , h ) ,$$

wherein W comprises a width of an input image;

wherein H comprises a height of the input image;

wherein UOHₒ comprises a UOH (virtual UOH) when a template is added to all particles; and

argmin comprises a function to calculate an argument of minimum value for the expression

$${\sum }_{w = 1}^{W} {\sum }_{h = 1}^{H} {UOH}_{o} ( w , h ) .$$

There are numerous methods and techniques to calculate such a minimum, and those of skill in the art will be able to select the most appropriate minimization function to best suit each particular circumstance. FIG. 5C illustrates an example of a result 530 of such an optimization and minimization process.

In an embodiment, the object is added at operation 140 to a particle in the particle set if a generated random number is less than a particular threshold. The threshold may be raised or lowered to result in the potential new object being added to more or less particles. A reason that a potential new object is not added to every particle is that when a potential new object is first initialized, it may turn out later that a new object is not in fact present, and adding the potential new object to all particles would waste resources. However, if the potential new object turns out to actually be present, the re-sampling step in a particle filter will select the particles with the new object, and discard the particles without the new object, thereby initializing the new object.

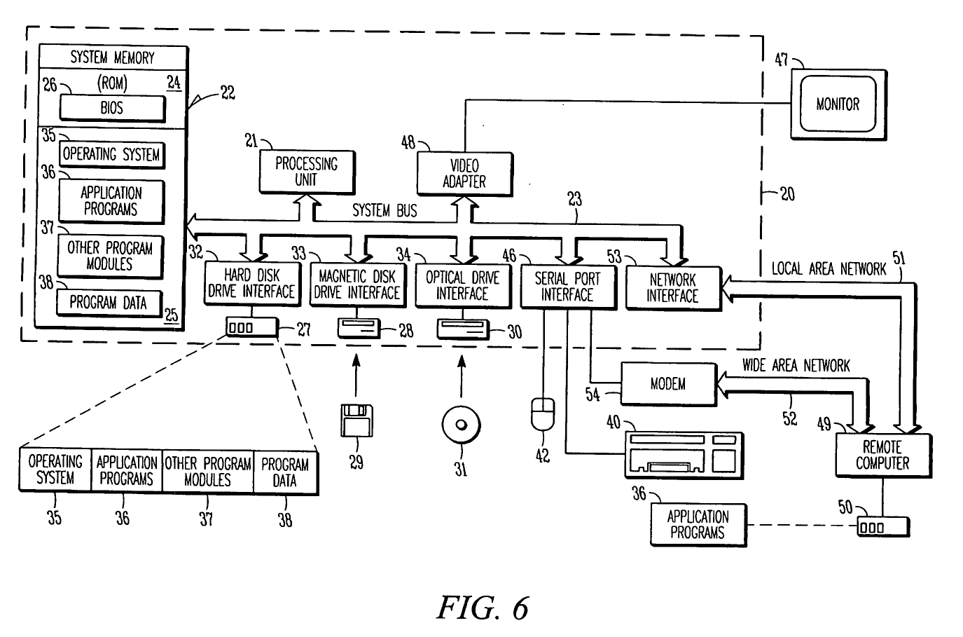

FIG. 6 is an overview diagram of a hardware and operating environment in conjunction with which embodiments of the invention may be practiced. The description of FIG. 6 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 6, a hardware and operating environment is provided that is applicable to any of the servers and/or remote clients shown in the other Figures.

As shown in FIG. 6, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/0 relative to the computer 20, although only a memory storage device 50 has been illustrated. The logical connections depicted in FIG. 6 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

Thus, a system and method for object initialization in video data has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Additionally, in the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A method comprising:
configuring a video system to:
track objects using a particle filter;
calculate a histogram indicating a number of particles that do not cover an input image at a position in said input image; and
initialize an object to be tracked in said input image as a function of said histogram.

2. The method of claim 1, wherein said initialization comprises an optimization algorithm using criteria based on said histogram.

3. The method of claim 1, wherein said histogram comprises an Uncovered Object Histogram (UOH), and further wherein said UOH is calculated by comparing each of said number of particles to said input image.

4. The method of claim 3, wherein said comparison comprises:
$$UOH ( w , h ) = \{ \begin{matrix}{\sum }_{i = 1}^{N} ( {v}_{i} ( w , h ) ) , & if q ( w , h ) = 1 , \\ 0 & otherwise .\end{matrix}$$
wherein q(w,h) comprises a binary value of an input image at a position w,h;
wherein vᵢ(w,h) comprises a binary value of a particle i at said position w,h; and
wherein N comprises said number of particles.

5. The method of claim 4, wherein said initialization further comprises positioning templates in a three-dimensional space based on said calculated UOH.

6. The method of claim 5, wherein said templates minimize said calculated UOH when said templates are added to all particles in said particle set.

7. The method of claim 6, wherein said minimization comprises positioning said templates as follows:
$$arg min {\sum }_{w = 1}^{W} {\sum }_{h = 1}^{H} {UOH}_{o} ( w , h ) ,$$
wherein W comprises a width of said input image;
wherein H comprises a height of said input image;
wherein UOHₒ comprises a UOH when a template is added to all particles; and
argmin comprises a function to calculate an argument of minimum value for the expression
$${\sum }_{w = 1}^{W} {\sum }_{h = 1}^{H} {UOH}_{o} ( w , h ) .$$

8. A system comprising:
a module to track objects using a particle filter;
a module to calculate a histogram indicating a number of particles that do not cover an input image at a position in said input image; and
a module to initialize an object to be tracked in said input image as a function of said histogram.

9. The system of claim 8, wherein said module to initialize comprises an optimization algorithm using criteria based on said histogram.

10. The system of claim 8, wherein said histogram comprises an Uncovered Object Histogram (UOH), and further comprising a module to calculate said UOH by comparing each of said number of particles to said input image.

11. The system of claim 10, wherein said calculation module comprises:
$$UOH ( w , h ) = \{ \begin{matrix}{\sum }_{i = 1}^{N} ( {v}_{i} ( w , h ) ) , & if q ( w , h ) = 1 , \\ 0 & otherwise .\end{matrix}$$
wherein q(w,h) comprises a binary value of an input image at a position w,h;
wherein vᵢ(w,h) comprises a binary value of a particle i at said position w,h; and
wherein N comprises said number of particles.

12. The system of claim 11, wherein said initialization module further comprises positioning templates in a three-dimensional space based on said calculated UOH.

13. The system of claim 12, wherein said templates minimize said calculated UOH when said templates are added to all particles in said particle set.

14. The system of claim 13, wherein said minimization comprises positioning said templates as follows:
$$arg min {\sum }_{w = 1}^{W} {\sum }_{h = 1}^{H} {UOH}_{o} ( w , h ) ,$$
wherein W comprises a width of said input image;
wherein H comprises a height of said input image;
wherein UOHₒ comprises a UOH when a template is added to all particles; and
argmin comprises a function to calculate an argument of minimum value for the expression
$${\sum }_{w = 1}^{W} {\sum }_{h = 1}^{H} {UOH}_{o} ( w , h ) .$$

15. A machine readable medium comprising instructions for executing a method comprising:
configuring a video system to:
track objects using a particle filter;
calculate a histogram indicating a number of particles that do not cover an input image at a position in said input image; and
initialize an object to be tracked in said input image as a function of said histogram.

16. The machine readable medium of claim 15, wherein said initialization comprises an optimization algorithm using criteria based on said histogram.

17. The machine readable medium of claim 15, wherein said histogram comprises an Uncovered Object Histogram (UOH), and further wherein said UOH is calculated by comparing each of said number of particles to said input image.

18. The machine readable medium of claim 17, wherein said comparison comprises:
$$UOH ( w , h ) = \{ \begin{matrix}{\sum }_{i = 1}^{N} ( {v}_{i} ( w , h ) ) , & if q ( w , h ) = 1 , \\ 0 & otherwise .\end{matrix}$$
wherein q(w,h) comprises a binary value of an input image at a position w,h;
wherein vᵢ(w,h) comprises a binary value of a particle i at said position w,h; and
wherein N comprises said number of particles.

19. The machine readable medium of claim 18, wherein said initialization further comprises positioning templates in a three-dimensional space based on said calculated UOH.

20. The machine readable medium of claim 19, wherein
said templates minimize said calculated UOH when said templates are added to all particles in said particle set; and further wherein
said minimization comprises positioning said templates as follows:
$$arg min {\sum }_{w = 1}^{W} {\sum }_{h = 1}^{H} {UOH}_{o} ( w , h ) ,$$
wherein W comprises a width of said input image;
wherein H comprises a height of said input image;
wherein UOHₒ comprises a UOH when a template is added to all particles; and
argmin comprises a function to calculate an argument of minimum value for the expression
$${\sum }_{w = 1}^{W} {\sum }_{h = 1}^{H} {UOH}_{o} ( w , h ) .$$
